(19) United States
(12) Patent Application Publication
(10) Pub. No.: US 2012/0193186 A1
(43) Pub. Date: Aug. 2, 2012

(54) Transmission Clutch Assembly

(75) Inventors: Steven Anatole Frait, Milan, MI (US); Jeffrey Edward Maurer, Commerce, MI (US)

(73) Assignee: Ford Global Technologies LLC

(21) Appl. No.: 13/019,990

(22) Filed: Feb. 2, 2011

(51) Int. Cl. F16D 25/12; B23P 11/00

(52) U.S. Cl. 192/85.01; 29/428

(57) ABSTRACT

The present disclosure relates to a vehicle transmission having a clutch assembly with a plurality of corrugations formed with respect to a hydraulic feed path for an apply piston.

### TECHNICAL FIELD

The present disclosure relates to vehicle transmissions, more specifically techniques for hydraulic clutch assemblies.

### BACKGROUND

Many conventional vehicle transmissions employ hydraulic clutches to accomplish gear shifting. Fluid is directed to a hydraulic piston to actuate the clutch pack. Delays in achieving a target pressure for clutch actuation can cause delays in shifting. Moreover, with the increased number of speeds in automatic transmissions there comes an increased packaging demand on the transmission. It becomes necessary to fit more hardware in the same prescribed length. Modern transmissions generally have a clutch piston of a relatively small diameter, located near a center shaft (and transmission fluid source) to improve shift timing; however, doing so generally adds length to the transmission.

U.S. Pat. No. 7,001,298 titled “Clutch System for a Transmission” teaches a transmission lubrication system having corrugations routed to a planetary gear set. Though corrugations are taught therein, this design, does not accomplish management of the application of a distally mounted apply piston (and clutch pack) which makes available more axial packaging space in the transmission.

Therefore, it is desirable to have a transmission that increases packaging space by enabling more distal mounting of the clutch piston with respect to the center shaft that still provides relatively low shift timing.

### SUMMARY

The present invention may address one or more of the above-mentioned issues. Other features and/or advantages may become apparent from the description which follows.

Certain embodiments of the present invention relate to a vehicle transmission clutch assembly, including: a hydraulic piston configured to actuate a clutch pack; a first cylinder and second cylinder defining a first hydraulic feed path in fluid communication with the piston; and a first plurality of corrugations formed in the first cylinder or second cylinder.

Other embodiments of the present invention relate to a vehicle transmission, including: a first clutch assembly having a first plurality of corrugations formed with respect to a first hydraulic feed path for an apply piston.

Another embodiment of the present invention relates to a method of manufacturing a vehicle transmission clutch assembly, the method including: forming a first hydraulic feed path configured to provide fluid to a clutch apply piston; and forming a first plurality of corrugations with respect to the first hydraulic feed path thereby reducing clutch apply time.

One advantage of the present teachings is that this design uses radial corrugations to improve transmission fluid to the flow area. This design also enables welding of three cylinders to give sufficient strength to resist part ballooning due to a hydraulic pressure when the clutch piston is applied.

Another advantage of the present teachings is that by constructing a clutch assembly in the disclosed manner, the axial length of the transmission is shorter than the cast parts would otherwise be.

Yet another advantage of the present teachings is that the construction of corrugations in the hydraulic feed path reduces cost and component inertia. The cylinder geometry can be formed in a simple stamping process not requiring additional manufacturing steps.

Another benefit of the present teachings is that the corrugations added to the hydraulic feed path enables radial flow, greatly increasing transmission fluid flow area, unlike typical feeds that require multiple drilled holes.

In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

The invention will be explained in greater detail below by way of example with reference to the figures, in which the same reference numbers are used in the figures for identical or essentially identical elements. The above features and advantages and other features and advantages of the present invention are readily apparent from the following detailed description of the best modes for carrying out the invention when taken in connection with the accompanying drawings. In the figures:

### BRIEF DESCRIPTION OF THE DRAWINGS

FIG. 1 is a cross-sectional view of an exemplary vehicle transmission.

FIG. 2 is a cross-sectional view of the clutch assembly of FIG. 1.

FIG. 3 is a front view of a cylinder compatible with the clutch assembly of FIG. 2.

FIG. 4 is a cross-sectional view of the cylinder of FIG. 3.

FIG. 5 is a perspective view of a section of the cylinder of FIG. 3.

FIG. 6 is a front view of a cylinder compatible with the clutch assembly of FIG. 2.

FIG. 7 is a cross-sectional view of the cylinder of FIG. 6.

Although the following detailed description makes reference to illustrative embodiments, many alternatives, modifications, and variations thereof will be apparent to those skilled in the art. Accordingly, it is intended that the claimed subject matter be viewed broadly.

### DETAILED DESCRIPTION

Referring to the drawings, wherein like characters represent the same or corresponding parts throughout the several views there are shown exemplary transmission clutch assemblies. The clutch assemblies are hydraulic clutch assemblies. Clutch assemblies are compatible with both manual and automatic transmissions. Transmissions can be any number of speeds including five-, six-, seven- and eight-speed transmissions. Continuously variable and electrically variable transmissions are compatible with the clutch assemblies disclosed herein.

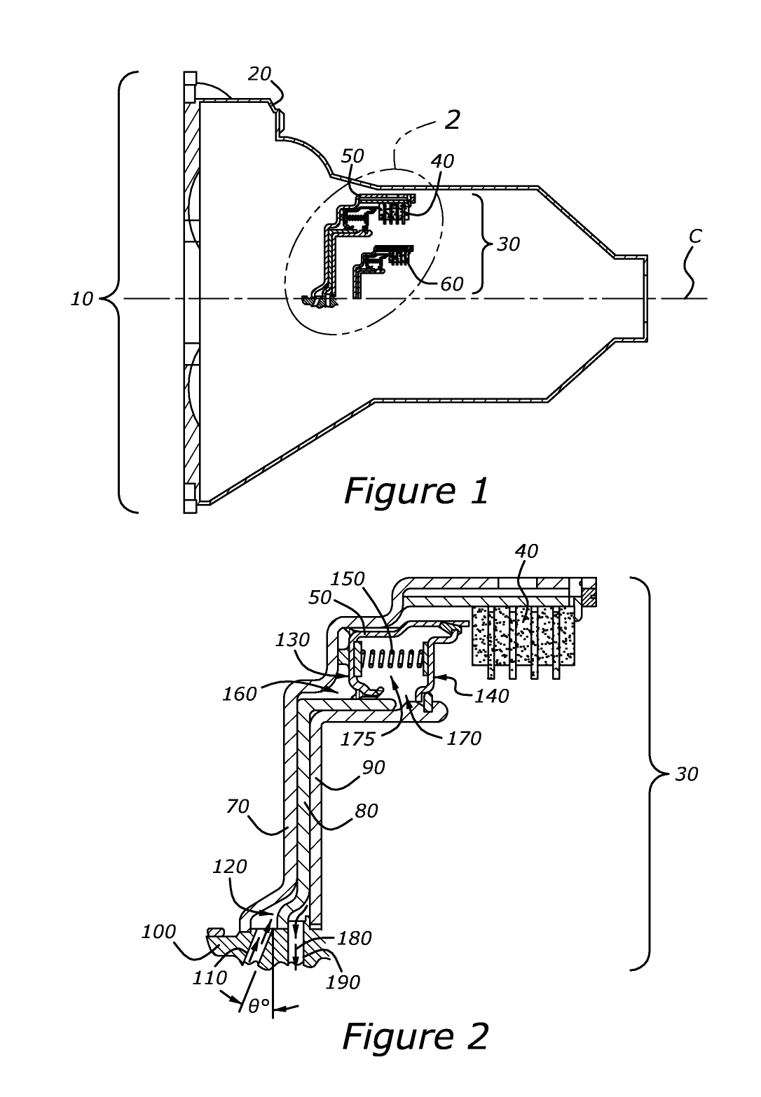

Referring now to FIG. 1, there is shown therein a partial cross-sectional view of an exemplary automatic vehicle transmission 10. A transmission housing 20 is outlined. A center line, C, represents the center of the transmission and where a center shaft is positioned. The interior of the transmission is removed with the exception of a top portion of a clutch assembly 30. Clutch assembly 30 is encircled by Circle 2. Clutch 40 is used to link two different kinematic elements together within the transmission in order to accomplish gear shifting. Clutch assembly 30 includes an apply piston 50 that is positioned at a relatively distal position with respect to the center shaft or centerline C. Clutch assembly 30 is one of multiple clutch assemblies incorporated into the transmission 10. Another clutch assembly 60 can be nested within the clutch assembly 30 (e.g., as shown in phantom in FIG. 1). The distant position of apply piston 50 enables the additional clutch assembly 60 to occupy a similar axial space as clutch assembly 30. The length of the transmission 10 is significantly reduced by the length of at least one clutch assembly. In other embodiments, multiple clutches are nested or stacked with respect to other distally positioned clutch assemblies.

FIG. 2 emphasizes the clutch assembly 30 from the transmission of FIG. 1. The clutch assembly 30 is a hydraulic clutch having a clutch pack 40 positioned with respect to apply piston 50. The assembly includes a three-cylinder arrangement for guiding fluid to and away from the piston 50. Cylinders 70, 80 and 90 are formed through a stamping process. In this embodiment, cylinders 70, 80 and 90 are attached to a central hub 100 in the transmission. Cylinder 70 is attached to cylinder 80 via a welding operation (e.g., laser or spot welding). Cylinder 80 is attached to cylinder 90 via a welding operation as well. In other embodiments, cylinders 70, 80 and 90 are attached to one another or other transmission components (e.g., hub 100) using welding or other techniques, such as, for example, press fitting, the use of fasteners or brazing. In yet another embodiment, cylinders 70, 80 and 90 are not attached to hub 100. Cylinders 70, 80 and 90 are formed of aluminum composite. In other embodiments, cylinders are formed of other metals, e.g., titanium, steel or magnesium compounds.

Hub 100, as shown in FIG. 2, can be any shaft, housing or surface included in the transmission 10. In this embodiment, hub 100 is a surface positioned with respect to the transmission center shaft. Hub 100 includes an aperture 110 for feeding transmission fluid to a hydraulic feed path 120 defined by cylinder 70 and cylinder 80. Aperture 110 is positioned on an angle, theta, as shown in FIG. 2. In other embodiments, aperture 110 is positioned at an angle less than or greater than theta.

Piston 50 includes an apply side 130, a reaction side 140 and a return spring 150. Aperture 110 is in fluid communication with hydraulic feed path 120 that supplies fluid to the apply side 130 of the piston 50. In this embodiment, the apply pressure for the piston 50 is approximately 250 psi. When fluid is not sufficiently applied, return spring 150 balances piston 50. Cylinder 70 and cylinder 80 define a cylinder bore 160. Hydraulic feed path 120 runs in the cylinder bore 160. Cylinder 80 and cylinder 90 define another cylinder bore 170. A hydraulic feed path 180 runs in the cylinder bore 170 through cylinder 80 and cylinder 90. Feed path 180 is an apply exhaust path from cylinder bore 170 and keeps fluid in a centrifugal balance cavity 175 of piston 50. Aperture 190 guides fluid away from hydraulic feed path 180. In the illustrated embodiment, aperture 190 is positioned vertically with respect to the hub 100; theta is equal to zero.

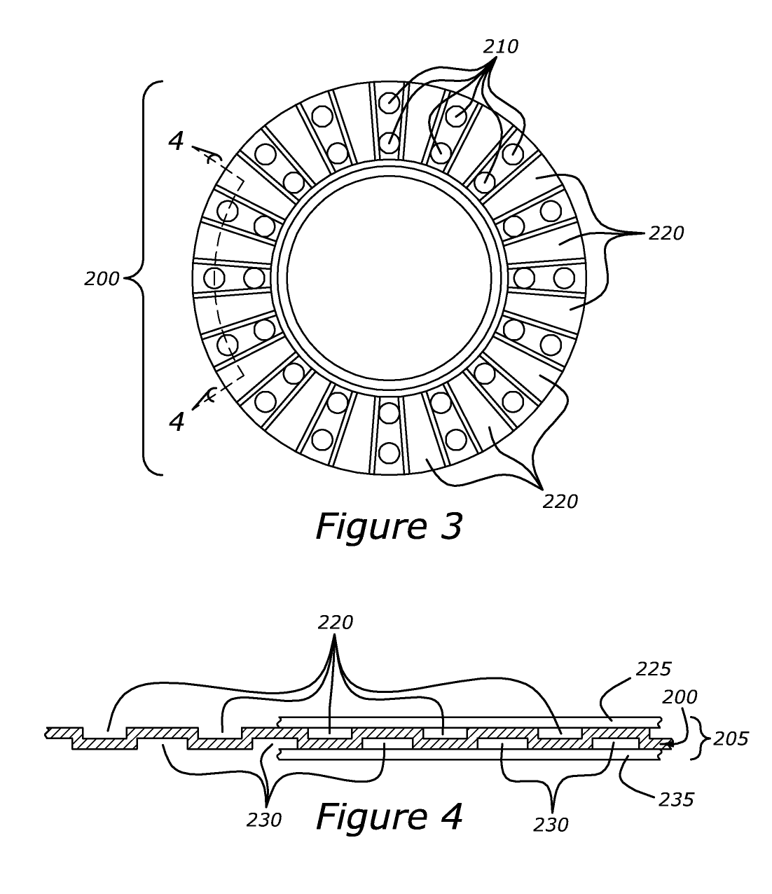

Cylinders 70, 80 and 90 are configured to have a plurality of corrugations extending between mating surfaces to increase fluid flow area, as shown in the exemplary embodiment of FIGS. 3-5. With respect to FIG. 3, there is an exemplary cylinder 200 shown therein. Corrugations can be a series of grooves, protrusions, and/or channels formed on a surface of the cylinder. Shown in FIG. 3 is cylinder 200 which has sixteen pairs of corrugations 220. Corrugations 220 are channels or flutes that extend from a surface of cylinder 200. Corrugations 220 are recesses on the surface of cylinder 200. Cylinder 200 is attached to another cylinder via projection welds 210.

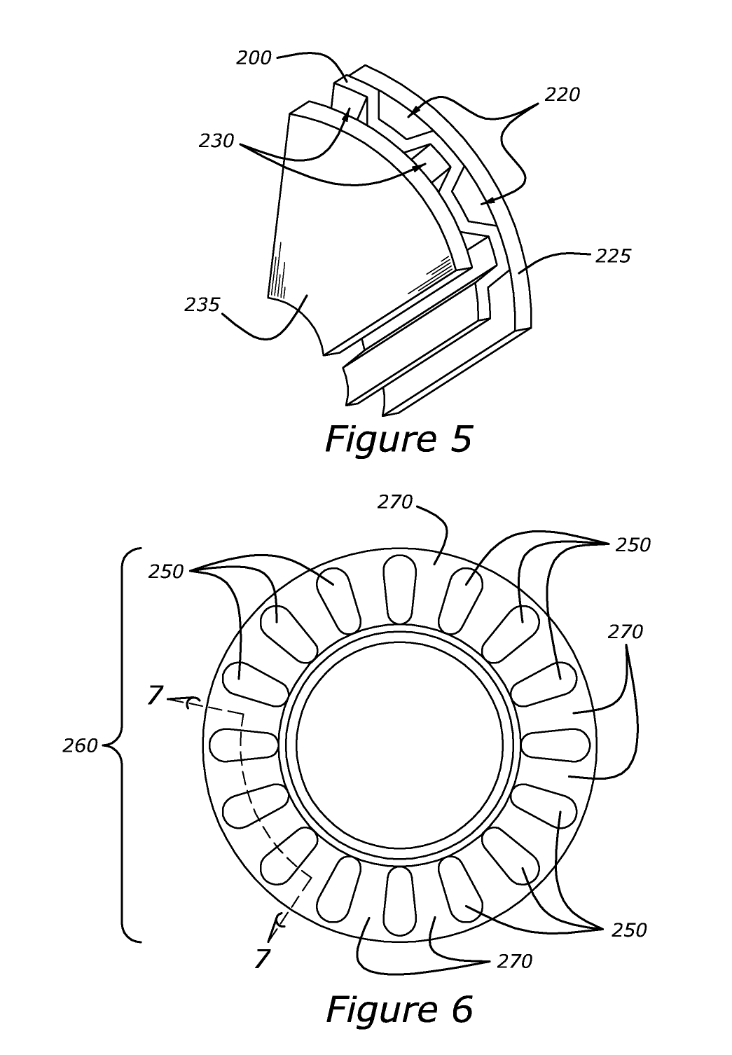

FIG. 4 is a cross-sectional view of cylinder 200 through arc 4-4 of FIG. 3. As shown, corrugations 220 are configured to extend through a hydraulic feed path. Shown is a three-piece cylinder assembly 205 for a clutch assembly (e.g., 30 as shown in FIG. 1). Corrugations 220 are configured to create undulations with respect to the surface of cylinder 200. With respect to FIGS. 4 and 5, cylinder 200 is placed between two cylinders 225 and 235. Balancing flutes 230 are provided on the opposite surface of cylinder 200. Flutes 230 form a balance dam fluid passage on the exhaust side of a piston.

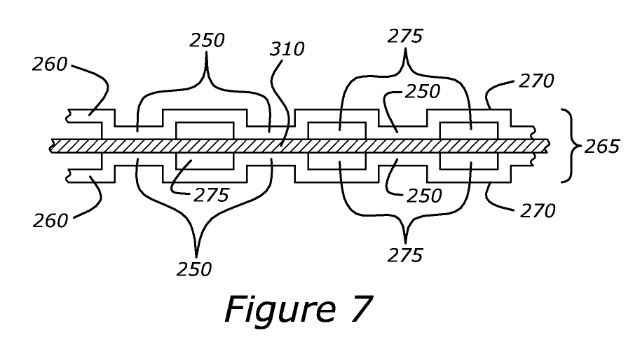

FIGS. 6 and 7 illustrate another exemplary set of corrugations 250 formed on a clutch assembly cylinder 260. Shown in FIG. 5 is cylinder 260 has sixteen pairs of corrugations 250. Corrugations 250 are v-shaped recesses that extend from the surface of cylinder 260. FIG. 7 is a cross-sectional view of the cylinder 260 through arc 7-7 of FIG. 6. As shown, corrugations 250 are configured to extend through a hydraulic feed path. Balancing corrugations 275 are also formed on the opposite side of the cylinder 260. The cylinder assembly 265 of FIG. 7 illustrates a three-piece cylinder arrangement with two corrugated cylinders 260 and one, flat center cylinder 310.

The illustrated corrugations extend radially with respect to the cylinders. In other embodiments, corrugations can extend parallel with respect to each other, circularly, in a jagged formation or be designed in any path or pattern.

Exemplary methods of manufacturing a vehicle transmission clutch assembly are also disclosed herein. The method includes the steps of forming a first hydraulic feed path configured to provide fluid to a clutch apply piston (for example as discussed with respect to FIGS. 1 and 2); and forming a first plurality of corrugations with respect to the first hydraulic feed path thereby reducing clutch apply time. In one embodiment, forming a first hydraulic feed path includes forming a first cylinder and second cylinder; and joining the first cylinder to the second cylinder thereby forming a fluid seal. In another embodiment, the method further includes forming a second hydraulic feed path in fluid communication with the clutch apply piston; and forming a second plurality of corrugations with respect to the second hydraulic feed path. The second hydraulic feed path exerts a balancing or off-setting pressure against the non-apply side of the piston.

It will be apparent to those skilled in the art that various modifications and variations can be made to the methodologies of the present invention without departing from the scope of its teachings. Other embodiments of the invention will be apparent to those skilled in the art from consideration of the specification and practice of the teachings disclosed herein. It is intended that the specification and examples be considered as exemplary only.

While the best modes for carrying out the invention have been described in detail, those familiar with the art to which this invention relates will recognize various alternative designs and embodiments for practicing the invention within the scope of the appended claims. In particular, the type and location of any device can vary from these examples. Also the sequence of steps in the methods can be altered; some steps can be omitted or added, etc.

We claim:

1. A vehicle transmission clutch assembly, comprising:
a hydraulic piston configured to actuate a clutch pack;
a first cylinder and second cylinder defining a first hydraulic feed path in fluid communication with the piston; and
a first plurality of corrugations formed in the first cylinder or second cylinder.

2. The clutch assembly of claim 1, wherein the first plurality of corrugations includes channels formed on a surface of the first cylinder or second cylinder.

3. The clutch assembly of claim 1, wherein the first plurality of corrugations includes recesses formed on the surface of the first cylinder or second cylinder.

4. The clutch assembly of claim 1, wherein the first and second cylinders are joined to a hub.

5. The clutch assembly of claim 1, wherein the first cylinder is attached to the second cylinder.

6. The clutch assembly of claim 1, further comprising:
a third cylinder, the second cylinder and third cylinder defining a second hydraulic feed path in fluid communication with the piston.

7. The clutch assembly of claim 6, further comprising:
a second plurality of corrugations formed in the first cylinder or second cylinder.

8. The clutch assembly of claim 7, further comprising:
a first cylinder bore for applying the piston, defined by the first cylinder and second cylinder.

9. The clutch assembly of claim 8, further comprising:
a second cylinder bore for releasing the piston, defined by the second cylinder and third cylinder.

10. The clutch assembly of claim 1, wherein the piston is sufficiently spaced from a center shaft of the transmission so that another clutch assembly can nest in the clutch assembly.

11. A vehicle transmission, comprising:
a first clutch assembly having a first plurality of corrugations formed with respect to a first hydraulic feed path for an apply piston.

12. The transmission of claim 11, further comprising:
a second clutch assembly nested within the first clutch assembly.

13. The transmission of claim 11, wherein the first plurality of corrugations includes channels formed on a surface defining the hydraulic feed path.

14. The transmission of claim 11, wherein the first plurality of corrugations includes recesses formed on a surface defining the hydraulic feed path.

15. The transmission of claim 11, further comprising:
a first cylinder and second cylinder defining the first hydraulic feed path;
wherein the first and second cylinders are joined to a hub.

16. The transmission of claim 15, wherein the first cylinder is attached to the second cylinder.

17. The transmission of claim 11, further comprising:
a second plurality of corrugations formed with respect to a second hydraulic feed path.

18. A method of manufacturing a vehicle transmission clutch assembly, comprising:
forming a first hydraulic feed path configured to provide fluid to a clutch apply piston; and
forming a first plurality of corrugations with respect to the first hydraulic feed path thereby reducing clutch apply time.

19. The method of claim 18, wherein the forming a first hydraulic feed path includes forming a first cylinder and second cylinder; and
joining the first cylinder to the second cylinder thereby forming a fluid seal.

20. The method of claim 18, further comprising:
forming a second hydraulic feed path in fluid communication with the clutch apply piston; and
forming a second plurality of corrugations with respect to the second hydraulic feed path.
